(19) United States
(12) Patent Application Publication
(10) Pub. No.: US 2025/0237777 A1
(43) Pub. Date: Jul. 24, 2025

(54) METHOD AND SYSTEM FOR DETERMINING PREDICTED SURFACE-RELATED MULTIPLES USING CONVOLUTION GATHERS

(71) Applicant: SAUDI ARABIAN OIL COMPANY, Dhahran (SA)

(72) Inventors: Dongliang Zhang, Khobar (SA); Constantinos Tsingas, Dhahran (SA); Mohammed S. Mubarak, Dhahran (SA)

(73) Assignee: SAUDI ARABIAN OIL COMPANY, Dhahran (SA)

(21) Appl. No.: 18/421,901

(22) Filed: Jan. 24, 2024

(51) Int. Cl. G01V 1/36; E21B 44/00; E21B 49/00; G01V 1/30

(52) U.S. Cl. CPC G01V 1/366; E21B 44/00; E21B 49/00; G01V 1/301; G01V 1/303; G01V 2210/24; G01V 2210/62

(57) ABSTRACT

A method may include obtaining seismic data regarding a geological region of interest. The seismic data may include an offset gather that includes various seismic traces sorted into an offset domain. The method may further include determining a pair of offset gathers based on a predetermined multiple surface location and the offset gather. The method may further include determining a trace index map for the pair of offset gathers. The method may further include generating, iteratively, a convolution gather that includes various convolution traces and based on a convolution function and the trace index map. A respective convolution trace among the convolution traces may be determined using a first trace and a second trace from the pair of offset gathers. The method may further include determining a predicted surface-related multiple using the first convolution gather.

### BACKGROUND

Various seismic processing operations are performed on seismic data from a survey to convert time-based seismic data into a depth representation of a subsurface. For example, seismic processing operations may include surface multiple filtering and other seismic data correction operations. Likewise, seismic processing may also include application of seismic inversion techniques and migration algorithms to determine or update velocity models.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In general, in one aspect, embodiments relate to a method that includes obtaining seismic data regarding a geological region of interest. The seismic data includes an offset gather that includes various seismic traces sorted into an offset domain. The method further includes determining, by a computer processor, a pair of offset gathers based on a predetermined multiple surface location and the offset gather. The method further includes determining, by the computer processor, a trace index map for the pair of offset gathers. The method further includes generating, iteratively by the computer processor, a convolution gather that includes various convolution traces and based on a convolution function and the trace index map. A respective convolution trace among the convolution traces is determined using a first trace and a second trace from the pair of offset gathers. The method further includes determining, by the computer processor, a predicted surface-related multiple using the first convolution gather. The method further includes generating, by the computer processor, filtered seismic data based on the predicted surface-related multiple and the seismic data.

In general, in one aspect, embodiments relate to a system that includes a seismic surveying system that includes various seismic receivers and a seismic source. The system further includes a seismic interpreter that includes a computer processor. The seismic interpreter is coupled to the seismic surveying system. The seismic interpreter obtains seismic data regarding a geological region of interest. The seismic data is acquired using the seismic surveying system. The seismic interpreter further determines a pair of offset gathers based on a predetermined multiple surface location and the offset gather. The seismic interpreter further determines a trace index map for the pair of offset gathers. The seismic interpreter further determines generates, iteratively, a convolution gather that includes various convolution traces and based on a convolution function and the trace index map. A respective convolution trace among the convolution traces is determined using a first trace and a second trace from the pair of offset gathers. The seismic interpreter further determines a predicted surface-related multiple using the convolution gather. The seismic interpreter further generates filtered seismic data based on the predicted surface-related multiple and the seismic data.

In some embodiments, various pairs of offset gathers corresponding to an azimuth-offset domain are determined based on various predetermined multiple surface locations. A trace index map for the pairs of offset gathers may be determined. A convolution gather may be generated iteratively based on a convolution function and the trace index map. The predetermined multiple surface locations may vary in two spatial dimensions. In some embodiments, a trace index map corresponds to various predetermined multiple surface locations that vary in a single spatial dimension. In some embodiments, various convolution gathers may be accumulated for a geological region of interest and based on seismic data. Various predicted surface-related multiples may be determined based on the convolution gathers. An adaptive multiple subtraction operation may be performed on the seismic data based on the predicted surface-related multiples. The adaptive multiple subtraction operation may be based on least-squares adaptive filtering.

In some embodiments, a predicted surface-related multiple corresponds to a seismic reflection event that includes a seismic wave that has at least one downward reflection from a surface of the earth. In some embodiments, seismic data is acquired for a geological region of interest using a seismic surveying system that includes various seismic receivers and a seismic source. In some embodiments, a seismic image is generated for a geological region of interest based on filtered seismic data. A well path may be determined in the geological region of interest using the seismic image. A drilling operation may be performed using a drilling system and based on the well path. In some embodiments, a velocity model is generated for a geological region of interest using filtered seismic data and a seismic inversion process. A seismic image may be generated for the geological region of interest based on the velocity model. Various interfaces may be determined within the geological region of interest using the seismic image. A presence of hydrocarbons in the geological region of interest may be determined using the interfaces. In some embodiments, a predetermined multiple surface location corresponds to a location having a fixed offset between a seismic receiver and a seismic source.

In light of the structure and functions described above, embodiments of the invention may include respective means adapted to carry out various steps and functions defined above in accordance with one or more aspects and any one of the embodiments of one or more aspect described herein.

Other aspects of the disclosure will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIGS. 1, 2, 3A, 3B, 3C, 3D, 3E, 4A, and 4B show systems in accordance with one or more embodiments.

FIG. 5 shows a flowchart in accordance with one or more embodiments.

FIGS. 6, 7A, 7B, 8, 9A, 9B, 10A, 10B, 10C, 10D, 10E, and 10F show examples in accordance with one or more embodiments.

FIG. 11 shows a computing system in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

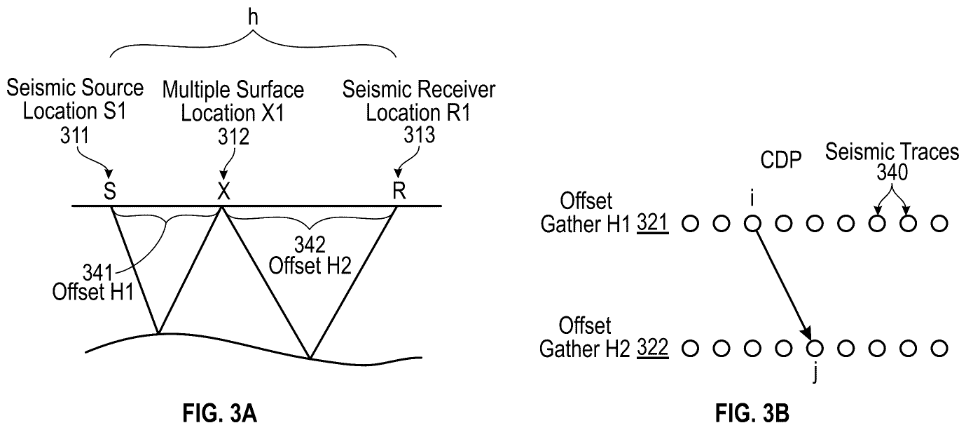

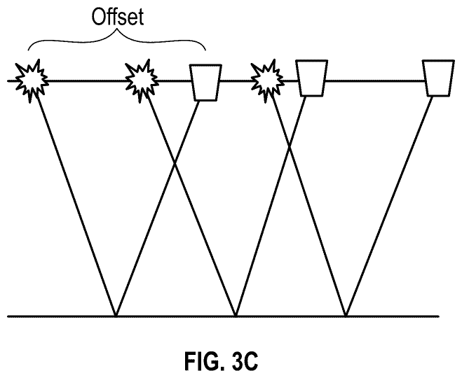

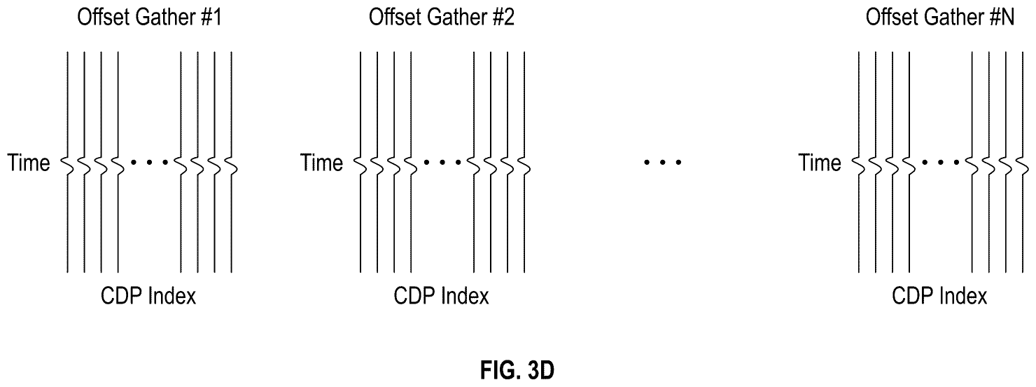

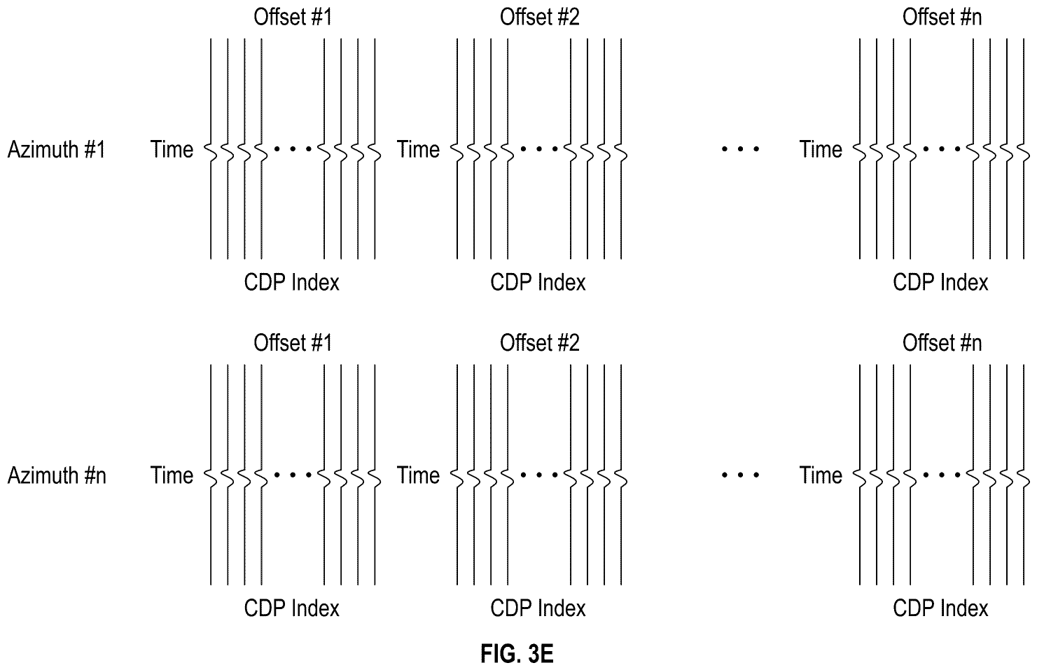

In general, embodiments of the disclosure include systems and methods for predicting and removing surface-related multiples using an iterative and sequential process to generate convolution gathers. In particular, the removal of surface-related multiples from raw seismic data may be a critical task, because such coherent noise can contaminate migrated seismic images and lead to erroneous geological interpretation of various subsurface regions. Accordingly, some embodiments are directed to determine a convolute trace using a convolution function and two seismic traces. One seismic trace may correspond to a multiple surface location having a specific offset between a seismic source location and where one or more surface-related multiple waves contact the surface. Additionally, the other seismic trace may correspond to a different offset between this multiple surface location and the location that a seismic receiver acquires a raw seismic trace. Based on these different offsets, seismic traces may be arranged according to different offset gathers. In some embodiments, an offset gather contains all seismic traces that have the same offset. Thus, the seismic traces may be arranged by sequential numbers that indicate different common midpoints (CMPs) or common depth points (CDPs) (see, e.g., FIG. 3C for an example of an offset gather).

By iteratively matching a seismic trace from one offset gather with a corresponding seismic trace from the other offset gather, a set of convoluted traces may be generated and used to form a convolution gather. As such, an accumulation of convolution gathers may be determined for various multiple surface locations to identify a predicted surface-related multiples. For a 2D geological region, different multiple surface locations along a single spatial axis may be used. For a 3D geological region, the multiple surface locations for the accumulated convolution gathers may correspond to two spatial axes in an azimuth-offset domain. After identification of the predicted surface-related multiples, one or more surface-related multiple removal techniques (e.g., adaptive multiple subtraction or curvelet-domain subtraction) may be subsequently applied to filter the coherent noise for use in other seismic data processing applications.

In some embodiments, a surface-related prediction process determines predicted multiple traces using one or more iterative loops based on the same offset gather h for a looped multiple surface location. In other words, an offset h between a seismic source location and a seismic receiver location may be divided into an offset h1 and an offset h2. As such, a required seismic trace at offset h1 and another required seismic trace at offset h2 may be used in a convolution function and selected from offset gather based on offset h1 and another offset gather based on offset h2. Therefore, two offset gathers i.e., h1 and h2, with seismic traces ordered by a trace index map (e.g., based on common depth points (CDPs) or common midpoints (CMPs)) can be sequentially read from a seismic data storage device. For example, the trace index map may be a single spatial axis for a 2D geological region, or a 2D surface map for a 3D geological region. By repeating this convolution procedure for other looped surface points at multiple surface locations (e.g., different X locations) and summing all convolved trace gathers at the same location (e.g., same CDP or CMP), the final surface-related multiple may be predicted for all seismic traces for an offset gather h (i.e., h1+h2).

Furthermore, various conventional techniques use a data-driven approach that employs convolutional techniques to predict multiples within a seismic dataset. For example, conventional techniques may analyze data shot gathers, receiver gathers, or common depth point (CDP) gathers. However, these conventional techniques may require seismic traces from multiple shots to predict multiples at a given location. As such, these conventional techniques may require significant data searching and random reading issues that impact performance of a multiple elimination process. Through the use of offset gathers, such as azimuth-offset gathers, a robust multiple elimination technique may be employed that overcomes various difficulties with past techniques.

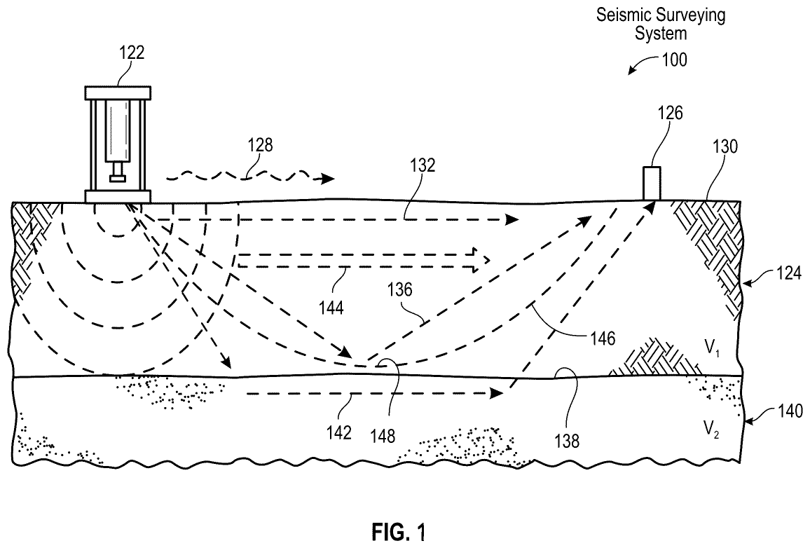

Turning to FIG. 1, FIG. 1 shows a schematic diagram in accordance with one or more embodiments. As shown in FIG. 1, FIG. 1 illustrates a seismic surveying system (100) and various resultant paths of seismic waves. The seismic surveying system (100) includes a seismic source (122) that includes functionality for generating seismic waves, such as a reflected wave (136), refracting wave (142), or diving wave (146), through a subsurface layer (124). Seismic waves generated by the seismic source (122) may travel along several paths through a subsurface layer (124) at a velocity V₁ for detection at a number of seismic receivers (126) along the line of profile. Likewise, velocity may refer to multiple velocities types, such as the two types of particle motions resulting from a seismic wave, i.e., velocity of the primary wave (P-wave) and a different velocity of the secondary wave (S-wave) through a particular medium. The seismic source (122) may be a seismic vibrator, such as one that uses a vibroseis technique, an air gun in the case of offshore seismic surveying, explosives, etc. The seismic receivers (126) may include geophones, hydrophones, accelerometers, and other sensing devices. Likewise, seismic receivers (126) may include single component sensors and/or multi-component sensors that measure seismic waves in multiple spatial axes.

As shown in FIG. 1, the seismic source (122) generates an air wave (128) formed by a portion of the emitted seismic energy, which travels above the earth's surface (130) to the seismic receivers (126). The seismic source (122) may also emit surface waves (132), which travel along the earth's surface (130). The speed of the surface waves (132), also called Rayleigh waves or ground roll, may correspond to a velocity typically slower than the velocity of a secondary wave. While the seismic surveying shown in FIG. 1 is a two-dimensional survey along a seismic profile along a longitudinal direction, other embodiments are contemplated, such as three-dimensional surveys.

Furthermore, subsurface layer (124) has a velocity V₁, while subsurface layer (140) has a velocity V₂. In words, different subsurface layers may correspond to different velocity values. In particular, a velocity may refer to the speed that a seismic wave travels through a medium, e.g., diving wave (146) that makes a curvilinear ray path (148) through subsurface layer (124). Velocity may depend on a particular medium's density and elasticity as well as various wave properties, such as the frequency of an emitted seismic wave. Where a velocity differs between two subsurface layers, this seismic impedance mismatch may result in a seismic reflection of a seismic wave. For example, FIG. 1 shows a seismic wave transmitted downwardly from the seismic source (122) to a subsurface interface (138), which becomes a reflected wave (136) transmitted upwardly in response to the seismic reflection. The seismic source (122) may also generate a direct wave (144) that travels directly from the seismic source (122) at the velocity V₁ through the subsurface layer (124) to the seismic receivers (126).

Turning to refracted seismic waves and diving seismic waves, the seismic source (122) may also generate a refracted wave (i.e., refracting wave (142)) that is refracted at the subsurface interface (138) and travels along the subsurface interface (138) for some distance as shown in FIG. 1 until traveling upwardly to the seismic receivers (126). As such, refracted seismic waves (e.g., refracted wave (142)) may be analyzed to map the subsurface layers (124, 140). For example, a refracted wave is a wave that a portion of ray path is along an interface of a reflector as show in refracting wave (142) in FIG. 1 (i.e., refraction exists only when V₂>V₁). On the other hand, a diving wave may be generated where velocities are gradually increasing with depth at a gradient (e.g., diving wave (146)), such that the diving wave may turn back along curvilinear ray path. Likewise, the apex of a diving wave may be consistent with a reflected seismic wave in a common midpoint (CMP) gather.

Furthermore, in analyzing seismic data acquired using the seismic surveying system (100), seismic wave propagation may be approximated using rays. For example, reflected waves (e.g., reflected wave (136)) and diving waves (e.g., diving wave (146)) may be scattered at the subsurface interface (138). In FIG. 1, for example, the diving wave (146) may exhibit a ray path of a wide angle that resembles a reflected wave in order to map the subsurface. Using diving waves, for example, a velocity model for an underlying subsurface may be generated that describes the velocity of different regions in different subsurface layers. An initial velocity model may be generated by modeling the velocity structure of media in the subsurface using an inversion of seismic data, typically referred to as seismic inversion. In seismic inversion, a velocity model is iteratively updated until the velocity model and the seismic data have a minimal amount of mismatch, e.g., the solution of the velocity model converges to a minimum that satisfies a predetermined criterion. For example, the optimization algorithm may be “linearized” and while achieving a “minimum”, there may be no guarantee that it is a global minimum rather than a local minimum. Thus, it may be a simplification commonly adapted in solving inverse problems that works when a respective objective function is convex.

With respect to velocity models, a velocity model may map various subsurface layers based on velocities in different layer sub-regions (e.g., P-wave velocity, S-wave velocity, and various anisotropic effects in the sub-region). For example, a velocity model may be used with P-wave and S-wave arrival times and arrival directions to locate seismic events. Anisotropy effects may correspond to subsurface properties that cause seismic waves to be directionally dependent. Thus, seismic anisotropy may correspond to various parameters in geophysics that refers to variations of wave velocities based on direction of propagation. One or more anisotropic algorithms may be performed to determine anisotropic effects, such as an anisotropic ray-tracing location algorithm or algorithms that use deviated-well sonic logs, vertical seismic profiles (VSPs), and core measurements. Likewise, a velocity model may include various velocity boundaries that define regions where rock types change, such as interfaces between different subsurface layers. In some embodiments, a velocity model is updated using one or more tomographic updates to adjust the velocity boundaries in the velocity model.

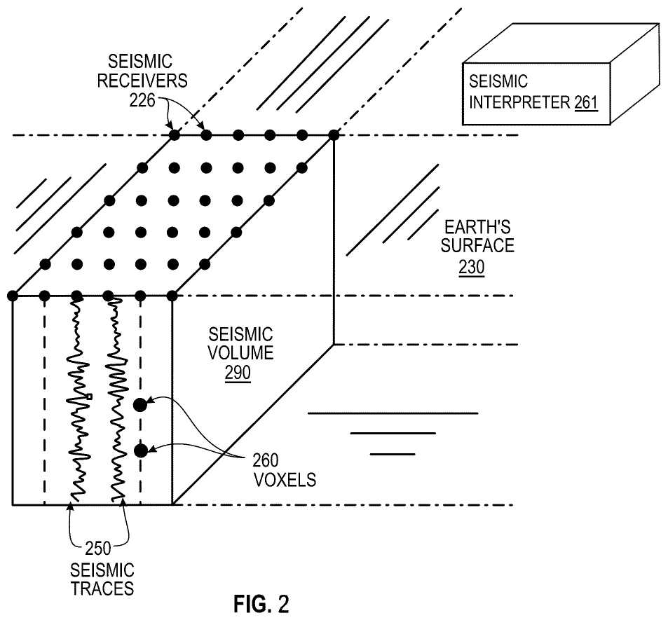

Turning to FIG. 2, FIG. 2 illustrates a system in accordance with one or more embodiments. As shown in FIG. 2, a seismic volume (290) is illustrated that includes various seismic traces (e.g., seismic traces (250)) acquired by various seismic receivers (e.g., seismic receivers (226)) disposed on the earth's surface (230). More specifically, a seismic volume (290) may be a cubic dataset of seismic traces. In particular, seismic data may have up to four spatial dimensions, one temporal dimension (i.e., related to the actual measurements stored in the traces), and possibly another temporal dimension related to time-lapse seismic surveys. Individual cubic cells within the seismic volume (290) may be referred to as voxels or volumetric pixels (e.g., voxels (260)). In particular, different portions of a seismic trace may correspond to various depth points within a volume of earth. To generate the seismic volume (290), a two-dimensional array of seismic receivers (226) are disposed along the earth's surface (230) and acquire seismic data in response to various seismic waves emitted by seismic sources. Within the voxels (260), statistics may be calculated on first break data that is assigned to a particular voxel to determine multimodal distributions of wave travel times and derive travel time estimates (e.g., according to mean, median, mode, standard deviation, kurtosis, and other suitable statistical accuracy analytical measures) related to azimuthal sectors. First break data may describe the onset arrival of refracted waves or diving waves at the seismic receivers (226) as produced by a particular seismic source signal generation.

Seismic data may refer to raw time domain data acquired from a seismic survey (e.g., acquired seismic data may result in the seismic volume (290)). However, seismic data may also refer to data acquired over different periods of time, such as in cases where seismic surveys are repeated to obtain time-lapse data. Seismic data may also refer to various seismic attributes derived in response to processing acquired seismic data. Furthermore, in some contexts, seismic data may also refer to depth data or image data. Likewise, seismic data may also refer to processed data, e.g., using a seismic inversion operation, to generate a velocity model of a subterranean formation, or a migrated seismic image of a rock formation within the earth's surface. Seismic data may also be pre-processed data, e.g., arranging time domain data within a two-dimensional shot gather.

Furthermore, seismic data may include various spatial coordinates, such as (x,y) coordinates for individual shots and (x,y) coordinates for individual receivers. As such, seismic data may be grouped into common shot or common receiver gathers. In some embodiments, seismic data is grouped based on a common domain, such as common midpoint (i.e., Xmidpoint=(Xshot+Xrec)/2, where Xshot corresponds to a position of a shot point and Xrec corresponds to a position of a seismic receiver) and common offset (i.e., Xoffset=Xshot−Xrec).

In some embodiments, seismic data is processed to generate one or more seismic images. For example, seismic imaging may be performed using a process called migration. In some embodiments, migration may transform pre-processed shot gathers from a data domain to an image domain that corresponds to depth data. In the data domain, seismic events in a shot gather may represent seismic events in the subsurface that were recorded in a field survey. In the image domain, seismic events in a migrated shot gather may represent geological interfaces in the subsurface. Likewise, various types of migration algorithms may be used in seismic imaging. For example, one type of migration algorithm corresponds to reverse time migration. In reverse time migration, seismic gathers may be analyzed by: 1) forward modelling of a seismic wavefield via mathematical modelling starting with a synthetic seismic source wavelet and a velocity model; 2) backward propagating the seismic data via mathematical modelling using the same velocity model; 3) cross-correlating the seismic wavefield based on the results of forward modeling and backward propagating; and 4) applying an imaging condition during the cross-correlation to generate a seismic image at each time step. The imaging condition may determine how to form an actual image by estimating cross-correlation between the source wavefield with the receiver wavefield under the basic assumption that the source wavefield represents the down-going wave-field and the receiver wave-field the up-going wave-field.

In Kirchhoff and other migration methods, for example, the imaging condition may include a summation of contributions resulting from the input data traces after the traces have been spread along portions of various isochrones (e.g., using principles of constructive and destructive interference to form the image). For example, Kirchhoff migration function may be based on an integral form of a wave equation that corresponds to pressure wave displacement and a pressure wave velocity as function of three-dimensional space and time. As such, 3D prestack Kirchhoff depth migration may be characterized as the summation of various reflection amplitudes along diffraction traveltime curves to obtain the output seismic images. As such, Kirchhoff algorithms may preprocess input seismic traces, determine traveltime tables for pressure waves using ray-tracing and a velocity model, and migrate these seismic traces. Besides Kirchhoff algorithms, other migration functions are also contemplated such as finite-difference migration, frequency-space migration, and frequency-wavenumber migration, and Stolt migration.

Keeping with migration functions, migration may also include a process of mapping seismic data onto an image that includes reflecting boundaries in the subsurface. Because migration techniques may rely on wavefield propagation estimates in the subsurface, poor velocity estimations may impact migration techniques that output one or more reflectivity maps in the depth domain. For example, poor velocity modeling may result in blurred images due to inaccurately mapping reflecting boundaries to the correct depths. Thus, wave equation migration velocity analysis (WEMVA) may be used to optimize modeling operators that are used to update one or more velocity models. In some embodiments, seismic full-waveform inversion (FWI) is used to determine velocity models by inverting a complete seismic dataset acquired for a particular geological region. FWI techniques may use local optimization approaches in cases where a reliable initial velocity model is available. The velocity model in FWI processes, unlike WEMVA techniques, may generate scattering in various modeling operators. FWI approaches may manage multiple scattering properly, but the FWI process may now experience reflecting errors based on high wavenumbers.

Furthermore, seismic data processing may include various seismic data functions that are performed using various process parameters and combinations of process parameter values. For example, a seismic interpreter may test different parameter values to obtain a desired result for further seismic processing. Depending on the seismic data processing algorithm, a result may be evaluated using different types of seismic data, such as directly on processed gathers, normal moveout corrected stacks of those gathers, or on migrated stacks using a migration function. Where structural information of the subsurface is being analyzed, migrated stacks of data may be used to evaluate seismic noise that may overlay various geological boundaries in the subsurface. As such, migrated images may be used to determine impact of noise removal processes, while the same noise removal processes may operate on gather data.

Additionally, seismic noise may include various multiples produces by one or more reflection interfaces. For example, multiples may refer to seismic events, where a pressure wave has undergone more than one reflection prior to arriving at a seismic receiver. Thus, multiples may be coherent noise in seismic data that resembles a primary seismic wave but with less energy content. Furthermore, multiples may include surface multiples that have at least one downward reflection from a water surface or a land surface. Likewise, multiples may include internal multiples that have all of their downward reflections at a water bottom or at other subsurface interfaces. Surface multiples may be stronger and more of a problem for seismic surveys than internal multiples because strong impedance contrasts may produce multiples strong enough to be recognized as primary seismic events. Furthermore, various multiple-elimination techniques may be used to remove one or more multiples from acquired seismic data. More specifically, multiple-elimination techniques may include adaptive multiple subtraction and other techniques.

In adaptive multiple subtraction, an initial step may include computing a multiple model within the subsurface based on 3D surface related multiple elimination and/or 3D wavefield modelling. For example, such prediction techniques may be data driven or use a reflectivity model of a geological region in order to determine predicted multiples. With multiple modeling, an amplitude of a multiple wave may be simulated using 3D operators, such as for determining amplitude decay while traversing the subsurface. After modeling one or more multiple waves, an adaptive multiple subtraction technique may remove the predicted multiple from a seismic dataset in produce filtered seismic data without the respective multiples. Various filtering technologies may be used such as curvelet-domain subtraction and least squares filtering (LSF) in the time-space (TX) domain. Such filtering techniques can be applied in the common channel, shot, or common mid-point domain. Other adaptive filtering parameters may include filter length, frequency sub-bands, time windows, and space windows.

Keeping with adaptive multiple subtraction, adaptive multiple subtraction may be presented as a least-squares minimization problem that minimizes the energy difference between the original input traces and the modeled multiple traces. Using adaptive noise cancellation, for example, an adaptive noise canceling system may have two signal inputs, one signal output, and a feedback loop. One signal input may include a desired seismic signal that has been corrupted by additive noise (e.g., a seismic trace with surface-related multiples). The other signal input is an estimate of the seismic noise that contaminates the corrupted signal (e.g., a seismic trace that only includes the predicted multiples). By convolving predicted seismic noise with a digital filter in an attempt to match the seismic noise that corrupts the desired signal, the adaptive noise cancellation system may adjust on a sample-by-sample basis or adapt filter coefficients to optimize a particular match.

Moreover, predicted multiples may also be removed from acquired seismic data using one or more curvelet subtraction techniques. For example, the curvelet domain may provide a sparse representation of seismic events within an acquired seismic dataset. In particular, seismic events of differing dip, scale or transmission location may be clearly separated in the curvelet domain. Using a curvelet transform, any 2D image may be represented as a collection of curvelet coefficients in the curvelet domain. Each curvelet coefficient may be thus identified by a multi-index. As such, curvelet-based subtraction methods may use an explicit objective function to determine curvelet-domain primaries and multiples. Another curvelet-based subtraction method may include transforming predicted multiples and acquired seismic data to the curvelet domain. Next, the curvelet coefficients of the predicted multiples may be adjusted to become “closer” to the curvelet coefficients of the acquired seismic data.

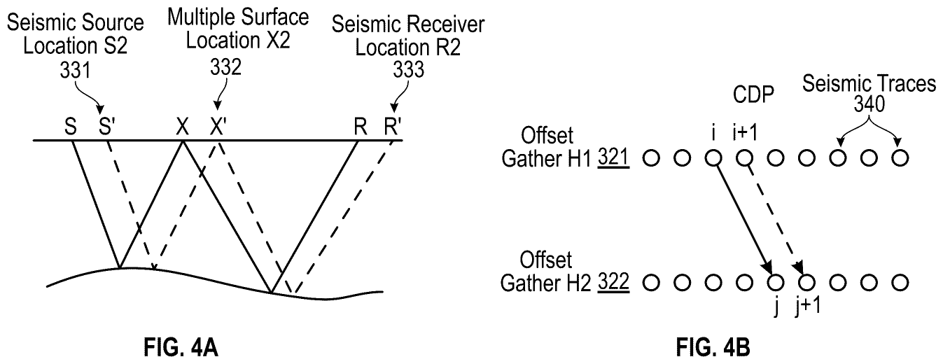

Turning to FIGS. 3A-3B and 4A-4B, FIGS. 3A-3B and 4A-4B illustrate a convolutional-based multiple prediction process is shown in accordance with one or more embodiments. This convolution-based prediction process may include various operations. First, this convolution-based prediction process may involve predicting various surface-related multiples within an acquired seismic dataset. Afterwards, the surface-related multiples may be removed from the original input data using one or more seismic processing techniques, such as adaptive multiple subtraction described above. To predict the surface-related multiple, a data driven convolutional approach methodology may be used. In some embodiments, this convolutional approach may be expressed mathematically using the following equation:

$$m ( s , r , t ) = \int f ( s , x , t ) * f ( x , r , t ) dx \qquad Equation 1$$

where m corresponds to one or more predicted multiples, f corresponds to various input seismic traces, s corresponds to various seismic source locations in one or more seismic surveys, and r corresponds to various receiver locations in one or more seismic surveys, and t represents the recording two-way travel time. Additionally, the integral element x is located at a free surface and is one-dimensional in the 2D case and two-dimensional (x1, x2) in the 3D case. The convolution operator (*) may be used to compute the predicted multiples by summing the travel-time of various seismic traces.

In FIG. 3A, a convoluted trace may be determined by convoluting seismic traces between a seismic source location (e.g., seismic source location S1 (311), seismic source location S2 (331)) and a multiple surface location along with seismic traces between the multiple surface location and the seismic receiver location (e.g., seismic receiver location R1 (313), seismic receiver location R2 (333)). As such, convoluted traces may be determined for all possible various multiple surface locations (e.g., multiple surface location X1 (312), multiple surface location X2 (332)) and using a summation process for all convolved traces SXR to generate a predicted multiple trace at seismic receiver R from a seismic source location S. As such, a convolutional model may be used in some embodiments for predicting surface-related multiples within an acquired seismic dataset. Accordingly, a convolution operator may be used to sum the travel time of seismic trace S1X1 and X1R1, where the multiple surface location X1 can be either a virtual receiver of seismic shot or a virtual source of seismic receiver.

Furthermore, to generate the multiple at receiver R1, the workflow involves convolving trace S1X and XR1, and then summing all possible SXRs (X is varied). Regardless of the shot domain, receiver domain, or offset domain, multiple prediction may include two steps: convolution and summation. In the shot domain, the prediction process may include a source S and receiver R that are fixed, and multiple surface locations X that are looped to generate convoluted traces. Then, all SXRs are summed to generate the surface-related multiple at receiver R. In the offset domain, the multiple surface location X is fixed first, and then all traces SR are looped to generate convoluted traces. After that, the location X is changed, and the same procedure is repeated. Finally, all SXRs convoluted traces for trace SR (S and R are fixed) are summed to generate the surface-related multiple at receiver R from shot S.

Throughout this disclosure, the term “multiple surface location” may not necessarily refer to an actual location of the multiple reflection on the earth's surface. This is because the location X of a multiple reflection for a trace SR may not be the same as the location X′ for the next trace S′R′ in an offset gather, as shown in FIG. 4A below. In referring to a fixed location X, a “multiple surface location” may refer to one or more locations having fixed offset (e.g., h1 and h2) for a pair of seismic traces, where SX=S′X′ and XR=X′R′.

Keeping with FIG. 3A, FIG. 3A illustrates one fixed looped multiple surface location X1 (312) with a fixed offset h1 (341) between a seismic source location S1 (311) and the multiple surface location (312) as well as a fixed offset h2 (342) between the multiple surface location (312) and a seismic receiver location (313) for one predicted multiple trace in accordance with one or more embodiments. As such, FIG. 3A shows a prediction of a surface-related multiple in the offset domain, where a convolved trace with offset h may be generated by convolving trace S1X1 with trace X1R1, where these two seismic traces are from different offset H1 (341) and offset H2 (342). In FIG. 3B, a trace index map based on common depth points is shown from offset gather H1 (321) to offset gather H2 (322). The CDP indices i and j in the trace index map represent the corresponding locations of the seismic traces (340) within their respective offset gather.

Turning to FIGS. 4A-4B, FIGS. 4A-4B illustrates a relationship of convolution for the current predicted multiple trace and next predicted multiple trace in the same offset gather. In FIG. 4A, a current predicted multiple trace SR has a solid line and the next predicted multiple trace S′R′ has a dashed line for the same offset gather H. In FIG. 4B, the CDP index map from offset gather H1 (321) to offset gather H2 (322). The required traces S′X′ and X′R′ for the convolution of the next predicted trace move one CDP from traces SX and XR in their offset gather domain.

Returning to FIG. 2, while seismic traces with zero offset are generally illustrated in FIG. 2, seismic traces may be stacked, migrated and/or used to generate an attribute volume derived from the underlying seismic traces. For example, an attribute volume may be a dataset where the seismic volume undergoes one or more processing techniques, such as amplitude-versus-offset (AVO) processing. In AVO processing, seismic data may be classified based on reflected amplitude variations due to the presence of hydrocarbon accumulations in a subsurface formation. With an AVO approach, seismic attributes of a subsurface interface may be determined from the dependence of the detected amplitude of seismic reflections on the angle of incidence of the seismic energy. This AVO processing may determine both a normal incidence coefficient of a seismic reflection, and/or a gradient component of the seismic reflection. Likewise, seismic data may be processed according to a pressure wave's apex. In particular, the apex may serve as a data gather point to sort first break picks for seismic data records or traces into offset bins based on the survey dimensional data (e.g., the x-y locations of the seismic receivers (226) on the earth surface (230)). The bins may include different numbers of traces and/or different coordinate dimensions.

Moreover, pressure waves may undergo seismic attenuation when traveling within a medium, such as the earth's subsurface. For example, seismic attenuation may be an intrinsic property of rocks that relates to energy dissipation as pressure waves propagate through the subsurface. As such, attenuation may result in the decay of wave amplitudes in inelastic media. Several types of seismic attenuation may occur, such as (1) geometrical spreading (i.e., a wavefront radiating from a point source is distributed over a spherical surface of increasing size), (2) scattering or elastic attenuation, and (3) absorption or anelastic attenuation. Scattering may be caused by heterogeneity levels in the subsurface. In particular, scattering may be used to identify rocks containing oil and gas that result in energy attenuation among high frequency seismic waves. Thus, frequency-dependent attenuation, such as scattering, can be used to detect hydrocarbons.

In some embodiments, one or more regularization processes may be performed on an acquired seismic dataset to produce regularized data. In particular, acquired seismic data may include irregular data that lacks a periodic spatial distribution or periodic interval of seismic traces throughout a coverage area for several reasons, including complex topography, cable feathering, editing of bad traces, and high acquisition cost. For example, three-dimensional (3D) land surveys, 3D ocean bottom cable (OBC) surveys, and 3D ocean bottom node (OBN) surveys may be irregular acquisitions during the seismic acquisition process due to limitations of surveying techniques and/or complex geological topography. As such, irregular data may provide poor results from various seismic data processes, such as seismic plane-wave processing, surface-related multiple elimination techniques, and migration algorithms. However, regularized and densely sampled seismic data may be required for many seismic data processing approaches, such as plane-wave processing, surface-related multiple elimination, etc.

Furthermore, regularization processes may perform data reconstruction, interpolation, and/or extrapolation on pre-stack seismic data to fill gaps in acquisition coverage and azimuth distributions as well as improve offsets. In particular, regularization processes may increase the number of seismic traces within an acquisition area, e.g., to increase fold or reduce bin sizes. For example, regularization processes may increase the number of seismic source locations and/or seismic receiver locations based on acquired seismic data. Regularized data may also be used to produce a regular grid of seismic data with a predetermined periodic interval (e.g., where the interval matches a desired number of seismic receiver locations and/or seismic source locations) for disposing various bin centers within the regular grid. Accordingly, regularized data may include interpolated seismic traces with a regular grid, interpolated source lines, and/or interpolated receiver lines. By mixing acquired seismic data and interpolated seismic data, various holes in a seismic survey may be eliminated in the offset and azimuth directions while amplitude variations may also be preserved with respect to offsets and azimuths (e.g., for AVO processing and/or AVAz processing). Examples of regularization processes include sinc interpolation, high-resolution Radon transform interpolation, artificial neural network applications, etc.

In some embodiments, a regularization process is performed using one or more Fourier transforms. For example, a multi-dimensional Fourier transform may be used to transform irregular seismic data with four spatial dimensions into interpolated seismic data regularized for a regular grid. For a Fourier summation of regularized data, Fourier coefficients may be solved iteratively using different sequences of solving operations. On the other hand, the frequency spectrum may be computed directly (i.e., rather than solving iteratively) using a Fast Fourier Transform (FFT) due to the spatial interval being constant. For example, Fourier coefficients in a Fourier transform may be solved recursively, beginning with a Fourier coefficient with the maximum seismic energy and proceeding down to the Fourier coefficient with the minimum seismic energy. An inverse irregular Fourier transform may be used to remove a particular Fourier coefficient from the input seismic data to produce seismic data in the frequency domain. After all Fourier coefficients from the input seismic data during an iterative process, the final updated input seismic data on the irregular grid may converge to zero. As such, the reconstructed regularized data may fit the acquired seismic data and meet one or more interpolation criteria. Once a forward Fourier transform has been performed on the input seismic data, a reverse irregular Fourier transform may be used to map the interpolated seismic traces to any seismic receiver locations.

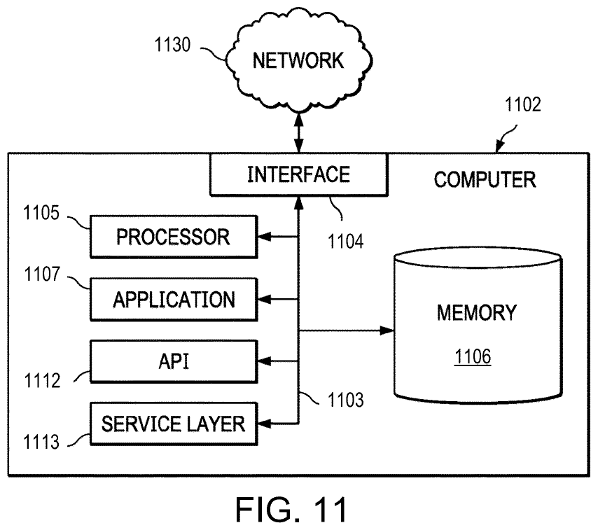

Turning to the seismic interpreter (261), a seismic interpreter (261) (also called a “seismic processing system”) may include hardware and/or software with functionality for storing the seismic volume (290), well logs, core sample data, and other data for seismic data processing, well data processing, and other data processes accordingly. In some embodiments, the seismic interpreter (261) may include a computer system that is similar to the computer (1102) described below with regard to FIG. 11 and the accompanying description. While a seismic interpreter may refer to one or more computer systems that are used for performing seismic data processing, the seismic interpreter may also refer to a human analyst performing seismic data processing in connection with a computer. While the seismic interpreter (261) is shown at a seismic surveying site, in some embodiments, the seismic interpreter (261) may be remote from a seismic surveying site.

Turning to geosteering, geosteering may be used to position the drill bit or drill string of the drilling system relative to a boundary between different subsurface layers (e.g., overlying, underlying, and lateral layers of a pay zone) during drilling operations. In particular, measuring rock properties during drilling may provide the drilling system with the ability to steer the drill bit in the direction of desired hydrocarbon concentrations. As such, a geosteering system may use various sensors located inside or adjacent to the drill string to determine different rock formations within a well path. In some geosteering systems, drilling tools may use resistivity or acoustic measurements to guide the drill bit during horizontal or lateral drilling. Likewise, a well path of a wellbore may be updated by a control system using a geophysical model (e.g., a model based on one or more seismic images). For example, a control system may communicate geosteering commands to the drilling system based on well data updates that are further adjusted by a simulator using a geophysical model. As such, the control system may generate one or more control signals for drilling equipment (or a logging system may generate for logging equipment) based on an updated well path design and/or a geophysical model.

Keeping with FIG. 2, a simulator (e.g., a reservoir simulator or a seismic interpreter (261)) may include hardware and/or software with functionality for generating and/or updating one or more machine-learning models to determine traveltime data, migrated seismic data, velocity model data, filtered seismic data, attenuation model data, and/or other simulation data. Examples of machine-learning models may include random forest models and artificial neural networks, such as convolutional neural networks, fully-connected neural networks, deep neural networks, and recurrent neural networks. Machine-learning models may also include support vector machines, decision trees, inductive learning models, deductive learning models, supervised learning models, unsupervised learning models, reinforcement learning models, and the like. In a deep neural network, for example, a layer of neurons may be trained on a predetermined list of features based on the previous network layer's output. Thus, as data progresses through the deep neural network, more complex features may be identified within the data by neurons in later layers. In some embodiments, two or more different types of machine-learning models are integrated into a single machine-learning architecture, e.g., a machine-learning model may include a random forest model and various neural networks. In some embodiments, a simulator may generate augmented data or synthetic data to produce a large amount of interpreted data for training a particular model.

Throughout this application, “obtain” and similar terminology is used in the context of actively or passively accessing data, such as seismic data. By way of example, a seismic interpreter may “obtain” a particular type of data (e.g., seismic data, well data, geological data, etc.) by actively transmitting a request to a remote server or a local data store to retrieve the specific data. On the other hand, a computer system may “obtain” data as a passive recipient to the data, such as through a user uploading one or more data files to a local storage device coupled to the computer system that is “obtaining” the data. In contrast, “acquire” and similar terminology is used in the context of actively harvesting data from a physical environment through sensors, electronic receivers (such as seismic receivers), and/or other hardware sensing mechanisms.

While FIGS. 1, 2, 3A, 3B, 4A, and 4B show various configurations of components, other configurations may be used without departing from the scope of the disclosure. For example, various components in FIGS. 1, 2, 3A, 3B, 4A, and 4B may be combined to create a single component. As another example, the functionality performed by a single component may be performed by two or more components.

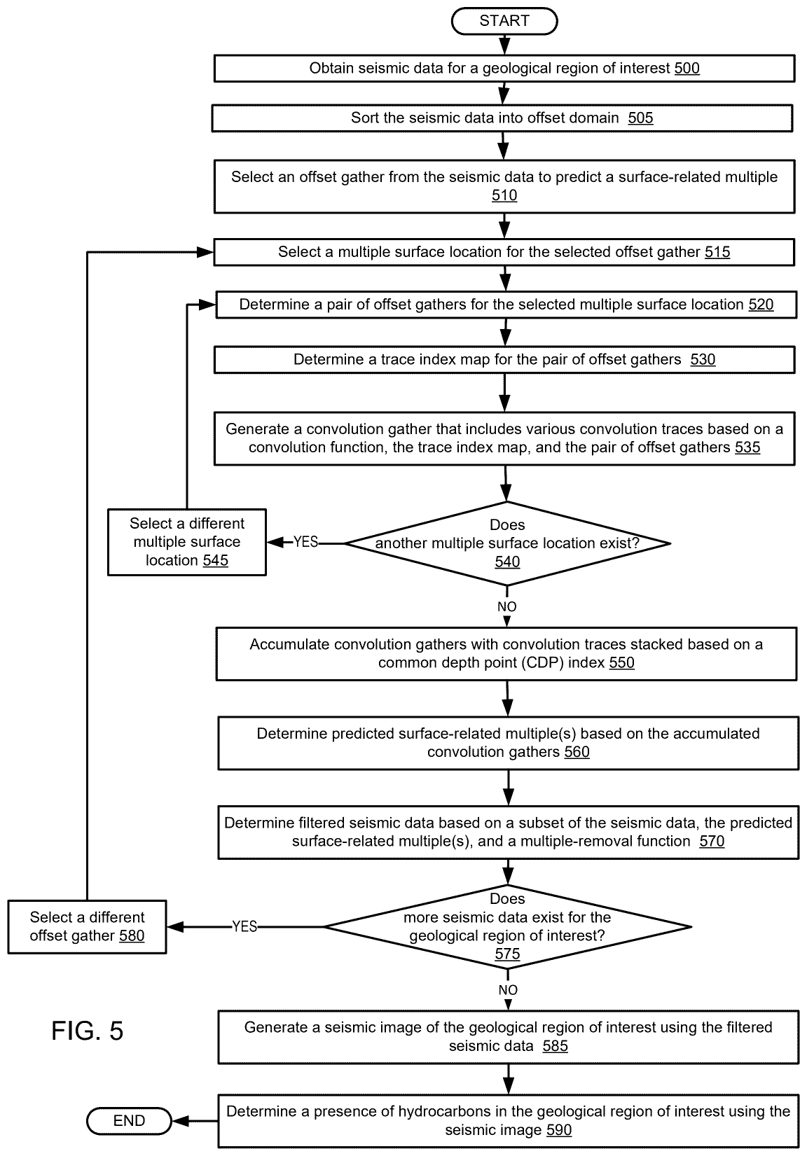

Turning to FIG. 5, FIG. 5 shows a flowchart in accordance with one or more embodiments. Specifically, FIG. 5 describes a general method for determining predicted multiples. One or more blocks in FIG. 5 may be performed by one or more components (e.g., seismic interpreter (261)) as described in FIGS. 12, 3A, 3B, 4A, and 4B. While the various blocks in FIG. 5 are presented and described sequentially, one of ordinary skill in the art will appreciate that some or all of the blocks may be executed in different orders, may be combined or omitted, and some or all of the blocks may be executed in parallel. Furthermore, the blocks may be performed actively or passively.

In Block 500, seismic data are obtained for a geological region of interest in accordance with one or more embodiments. Seismic data may be similar to the seismic data described above in FIGS. 1, 2, 3A-3B, and 4A-4B and the accompanying description. A geological region of interest may be a portion of a geological area or volume that includes one or more formations of interest desired or selected for analysis, e.g., for determining location of hydrocarbons or reservoir development purposes.

In Block 505, seismic data is sorted into an offset domain in accordance with one or more embodiments. For example, FIG. 3D shows various seismic traces being sorted in the offset domain, while FIG. 3E shows seismic traces being sorted according to an azimuth-offset domain.

In Block 510, an offset gather is selected from seismic data to predict a surface-related multiple in accordance with one or more embodiments. The selected offset gather may not necessarily not relate to a multiple surface location, but may simply include seismic data that is sorted into the offset domain. For example, the selected offset gather may correspond to the total offset between seismic source location S1 (311) and seismic receiver location R1 (313) shown in FIG. 3A.

In Block 515, a multiple surface location is selected for a selected offset gather in accordance with one or more embodiments. For example, the multiple surface location may correspond to a location on the surface that has a fixed offset with a seismic receiver and a seismic source. For a 2D multiple prediction, various multiple surface locations may be selected iteratively along a single spatial axis. For a 3D multiple prediction, the multiple surface locations may be selected iteratively along a two-dimensional plan, e.g., using two spatial axes.

In Block 520, a pair of offset gathers are determined for a selected multiple surface location in accordance with one or more embodiments. In particular, the pair of offset gathers may be selected from sorted seismic data in the offset domain. In some embodiments, for example, the pair of offset gathers are similar to the offset gathers described above in FIGS. 3B and 4B and the accompanying description. For example, an offset between a seismic source location and a seismic receiver location that records a seismic trace may be divided into offsets of different sizes. As such, one offset may correspond to a distance between a seismic source location and a multiple surface location of a predicted multiple. Additionally, another offset may correspond to a distance between the multiple surface location and the seismic receiver location.

In some embodiments, offset gathers are azimuth-offset gathers that are used to implement surface-related multiple predictions in the azimuth-offset domain for a three dimensional geological region of interest. For example, seismic traces in the azimuth-offset domain may be organized by azimuth as the primary order and offset as the secondary order. Within each azimuth-offset gather, seismic traces may be ordered according to a common depth point (CDP) sequence. In the case of 2D seismic data, the azimuth-offset domain may reduce to the offset domain, as only one azimuth exists. To predict surface-related multiples at a seismic receiver R from a shot S (i.e., a seismic trace SR) with an offset h, two seismic traces may be required for a looped point X (i.e., the multiple surface location) scanning various multiple surface locations between S and R as shown in FIG. 3A above.

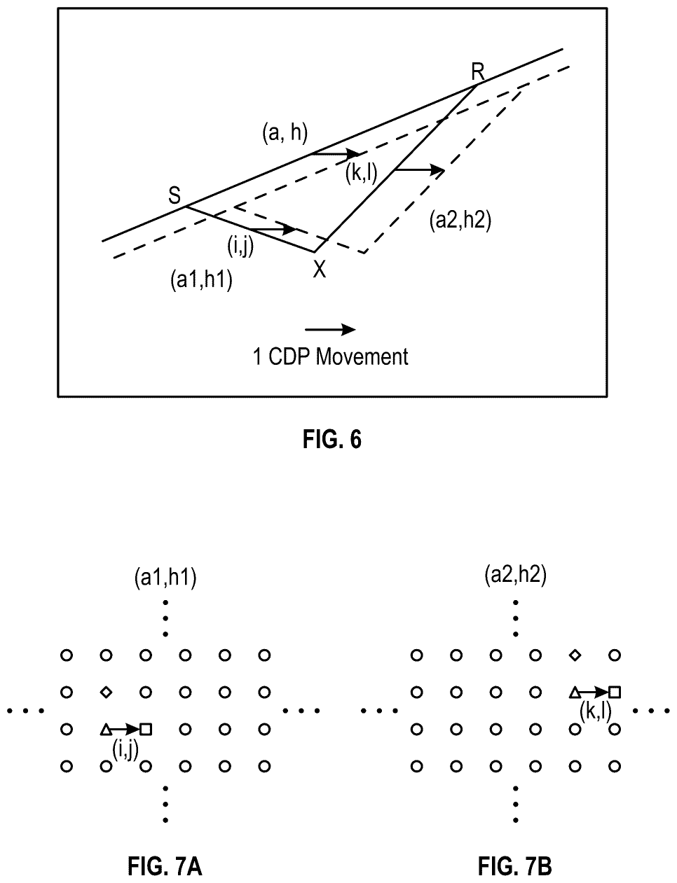

Turning to FIG. 6, FIG. 6 illustrate a 3D seismic surveying case for determining predicted multiples in accordance with one or more embodiments. In FIG. 6, a common depth point is shown as being two dimensional. Thus, a common depth point may be decomposed into its x and y dimensions, where each dimension may be considered separately. In the 3D case, a looped point x may be located outside the line SR, as shown in FIG. 6.

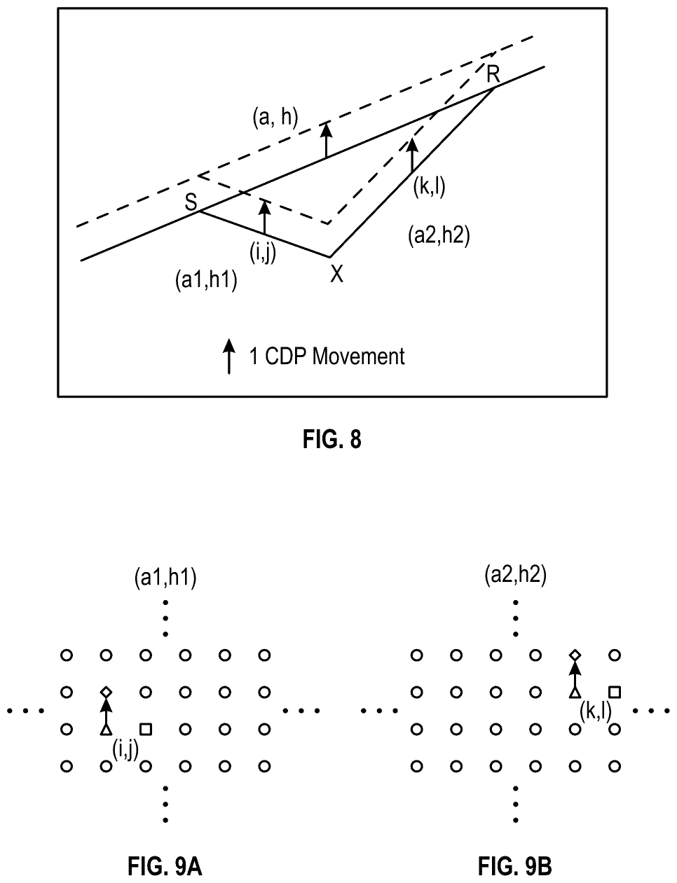

In FIG. 6, the planform of the convolution relation for the current predicted multiple trace (i.e., the solid line) and the next predicted multiple trace in the x direction (i.e., dashed line) is depicted accordingly. To predict the surface-related multiple for the current predicted multiple trace SR with an azimuth-offset (a, h), two seismic traces are used, i.e., SX with azimuth-offset (a1, h2) and XR with azimuth-offset (a2, h2), to convolve each other. For the next predicted multiple trace in the x direction, denoted by the dashed line, the predicted multiple trace moves one CDP in the x direction, and the two seismic traces move one CDP in the x dimension correspondingly. FIGS. 7A and 7B show the relationship of CDP locations of trace SX and XR for the current predicted trace and the next predicted trace, respectively. The dots in FIGS. 7A and 7B represent CDP locations, where yellow dots denote the current seismic traces SX and XR and their corresponding CDP indices (i, j) and (k, l). The segmented and dotted line represent the seismic traces for the next predicted trace, and their CDP indices have moved one CDP in the x direction, respectively. Thus, the seismic traces are sequentially distributed in the x direction. Moreover, the situation in the y direction is similar to that in the x direction. When the predicted multiple trace SR moves one CDP in the y direction from the current predicted multiple trace to the next predicted multiple trace, the two seismic traces SX and XR also move one CDP in the y direction, as shown in FIGS. 8, 9A, and 9B. The seismic traces are also sequentially distributed in the y direction. Similar to the 2D case, this sequential distribution of selected seismic traces SX and XR in the 3D seismic surveying case can avoid trace searching and random reading, resulting in high I/O efficiency.

In FIG. 8, FIG. 8 shows a map view of a convolution relationship for the current predicted multiple trace (i.e., solid lines) and the next predicted multiple trace in y direction (i.e., dashed lines). The movement from the current predicted multiple trace to the next predicted trace is one CDP in the y direction. Correspondingly, the two selected seismic traces also move one CDP in the y direction.

In FIGS. 9A and 9B, a CDP index map in the y direction of two selected offset gathers (i.e., offset gather (a1, h1) and offset gather (a2, h2)). The corresponding CDP indices of two selected seismic traces for the current and next predicted multiple traces are shown with different line styles, respectively. The movement in the y direction is one CDP in FIGS. 9A-9B.

Returning to FIG. 5, in Block 530, a trace index map is determined for a pair of offset gathers in accordance with one or more embodiments. For example, the trace index map is similar to the trace index maps described above in FIGS. 3B and 4B and the accompanying description or the CDP index map described above.

In Block 535, a convolution gather is generated that includes various convolution traces based on a convolution function, a trace index map, and a pair of offset gathers in accordance with one or more embodiments. For example, a seismic trace between a seismic received and a selected multiple location is convoluted with a seismic trace from the selected multiple location and a seismic receiver location. SX and XR. A convolution may be generated for the next trace in a selected offset gather h, until all traces in offset gather are convoluted. This resulting convolution gather may still be an offset gather that is ordered by a common depth point (CDP).

Returning to FIG. 6, FIG. 6 illustrates a mapview of a convolution relationship for the current predicted multiple trace (i.e., solid lines) and the next predicted multiple trace in x direction (i.e., dashed lines). In FIG. 6, the movement from the current predicted trace to the next predicted trace is one CDP in x direction, and correspondingly, the two selected seismic traces also move one CDP in x direction. In FIGS. 7A-7B, a CDP index map in the x direction of two selected offset gathers (i.e., offset gather (a1, h1) and offset gather (a2, h2)). Different CDP indices from the trace index map are indicated for two selected seismic traces for the current and next predicted multiple traces, respectively. The movement in the x direction is one CDP.

Returning to FIG. 5, in Block 540, a determination is made whether another multiple surface location exists in accordance with one or more embodiments. If the process determines that another multiple surface location exists within one or more spatial dimensions as required to determine a predicted surface-related multiple, the process may proceed to Block 545. If the process determines that no remaining multiple surface locations exist, the process may proceed to Block 550.

In Block 550, various convolution gathers are accumulated with convolution traces stacked based on a common depth point (CDP) index in accordance with one or more embodiments. After different convolution gathers are generated for different multiple surface locations (e.g., different X values in FIGS. 3A, 4A, and 6 above, a set of accumulated convolution gathers is produced. As such, all convoluted traces may be stacked with the same CDP in the convoluted gathers (3D) to generate a predicted multiple gather (2D). After stacking, these convolution gathers may be identified as corresponding to specific surface-related multiples within the seismic dataset.

In Block 560, one or more predicted surface-related multiples are determined based on accumulated convolution gathers in accordance with one or more embodiments.

In Block 570, filtered seismic data are determined based on a subset of seismic data, one or more predicted surface-related multiples, and a multiple-removal function in accordance with one or more embodiments. For example, the multiple-removal function may correspond to an adaptive multiple subtraction operation or another type of coherent noise elimination process.

In Block 575, a determination is made whether more seismic data exists for a geological region of interest in accordance with one or more embodiments. If the process determines that more seismic data exists, the process may proceed to Block 580. If the process determines that no more seismic data is present for the geological region of interest, the process may proceed to Block 585.

In Block 585, a seismic image is generated for a geological region of interest using filtered seismic data in accordance with one or more embodiments. In some embodiments, the seismic image provides a spatial and depth illustration of a subsurface formation for various practical applications, such as predicting hydrocarbon deposits, predicting wellbore paths for geosteering, etc. By removing coherent noise from the input seismic data, a seismic image using a desired seismic signal may be subsequently used for reservoir characterization and lithological identification.

In Block 590, a presence of hydrocarbons is determined in a geological region of interest using a seismic image in accordance with one or more embodiments.

In some embodiments, geosteering may be used to position the drill bit or drill string of a drilling system relative to a boundary between different subsurface layers (e.g., overlying, underlying, and lateral layers of a pay zone) during drilling operations. These different subsurface layers may be based one or more seismic images acquired from filtered seismic data. In particular, a geological model based on seismic data may be used by the drilling system for steering a drill bit in the direction of desired hydrocarbon concentrations. In some embodiments, a well path of a wellbore may be updated by the control system using a geological model. For example, a control system may communicate geosteering commands to the drilling system based on seismic survey data or predicted hydrocarbon data that are further adjusted by a seismic interpreter or reservoir simulator. As such, the control system may generate one or more control signals for drilling equipment (or a logging system may generate for logging equipment) based on an updated well path design and/or seismic data. As such, a geosteering system may use various sensors located inside or adjacent to the drill string to determine different rock formations within a well path. In some geosteering systems, drilling tools may use resistivity or acoustic measurements to guide the drill bit during horizontal or lateral drilling.

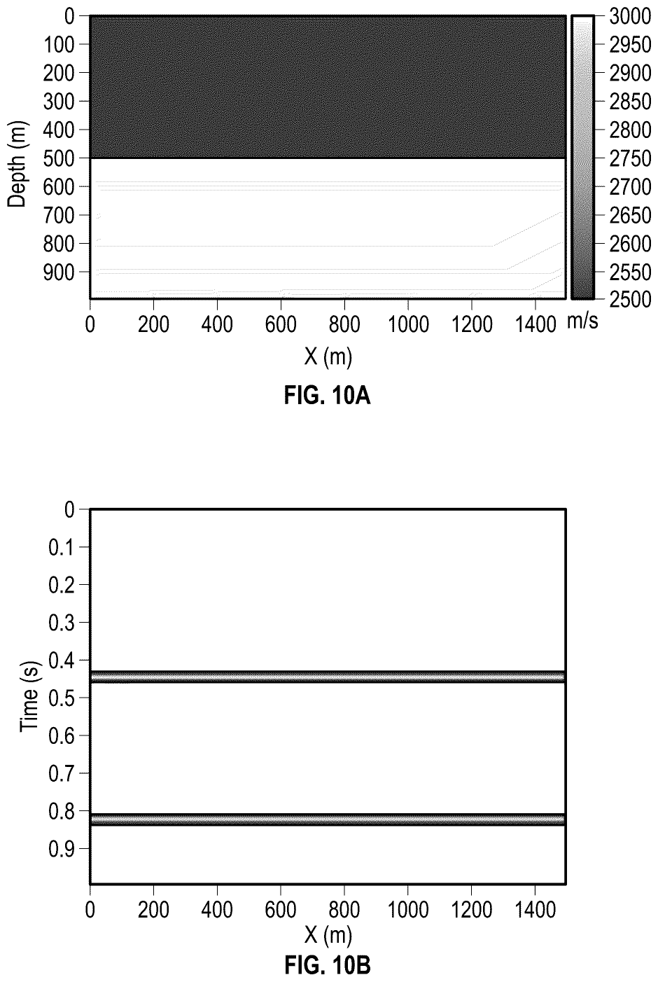

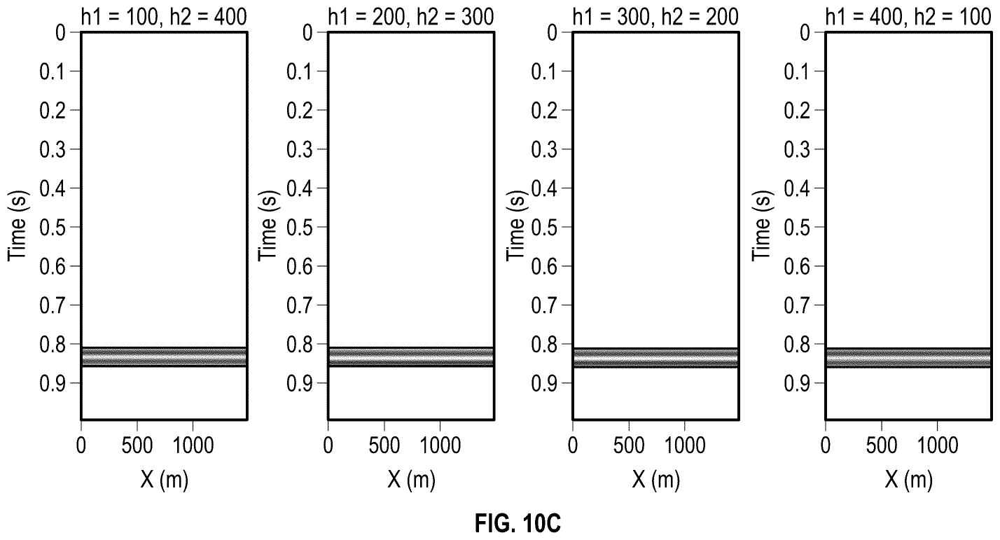

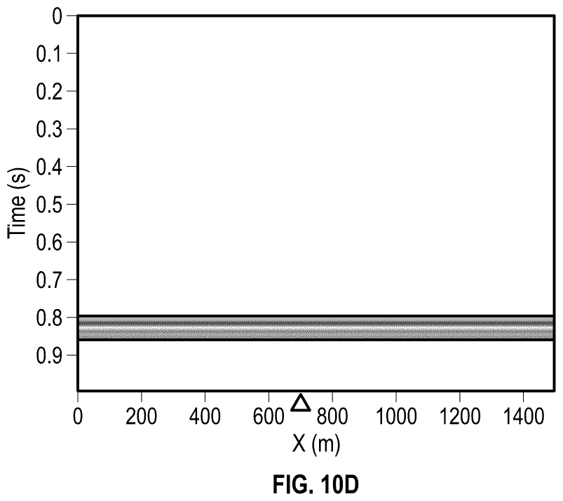

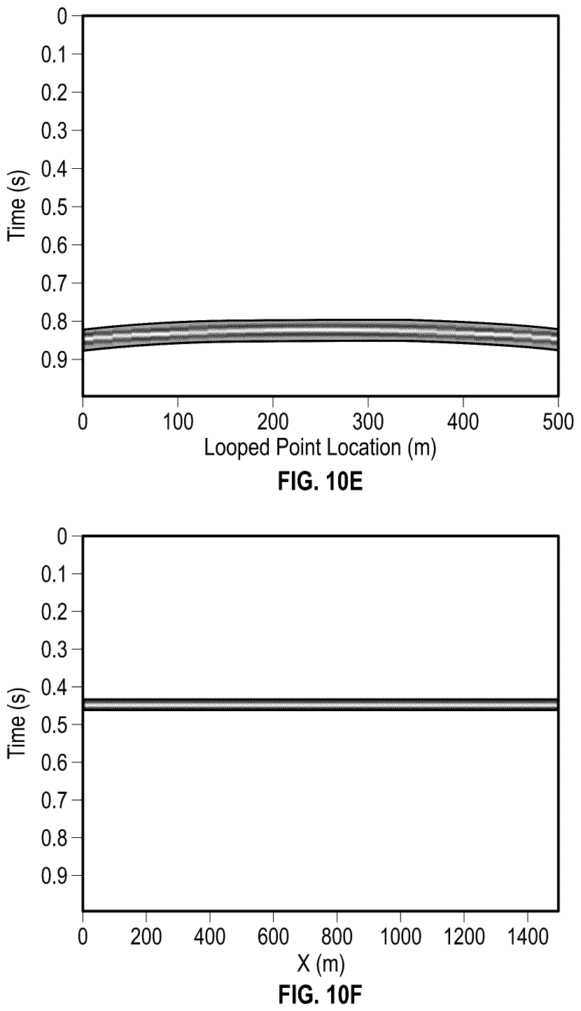

Turning to FIGS. 10A, 10B, 10C, 10D, 10E, and 10F, FIGS. 10A-10F provide examples in accordance with one or more embodiments. FIG. 10A shows a velocity model with two simple layers that is based on a synthetic dataset in 2D. FIG. 10B displays a gather at an offset of 500 m generated by this velocity model. In this gather, the first event is the primary, while the second event represents the first order of surface-related multiples. FIG. 10C presents several convolution gathers with pairs (h1, h2) of (100 m, 400 m), (200 m, 300 m), (300 m, 200 m), and (400 m, 100 m), respectively. Each convolution gather is generated by one looped point X (i.e., one penal in FIG. 10C). The final predicted surface-related multiple gather with offset 500 m is shown in FIG. 10D, which is obtained by summing all convolved gathers at the same CDP location. FIG. 10E shows a convolved gather at CDP location 700 m. After adaptively subtracting the predicted multiple model (i.e., FIG. 10D) from the original input seismic data gather (i.e., FIG. 10A), the primary event can be estimated (i.e., FIG. 10F). By repeating this process, all surface-related multiples with different offsets can be eliminated.

As shown in FIGS. 10A-10F, various convoluted gathers (i.e., as shown in FIG. 10B) are generated by looping through various multiple surface locations X. The summation of h1 and h2 is always 500 m, as this is the multiple prediction for offset gather h 500 m. The horizontal axis of panels is CDP. To generate the gather shown in FIG. 10E, select the trace with the same CDP number (for example, CDP 700) from these panels. Stacking all traces in the gather (i.e., FIG. 10E) generates a trace of the predicted surface-related multiple indicated by the triangle, as shown in FIG. 10D.

### Computer System

Embodiments may be implemented on a computer system. FIG. 11 is a block diagram of a computer system used to provide computational functionalities associated with described algorithms, methods, functions, processes, flows, and procedures as described in the instant disclosure, according to an implementation. The illustrated computer (1102) is intended to encompass any computing device such as a high-performance computing (HPC) device, a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer (1102) may include a computer that includes an input device, such as a keypad, keyboard, touch screen, or other device that can accept user information, and an output device that conveys information associated with the operation of the computer (1102), including digital data, visual, or audio information (or a combination of information), or a GUI.

The computer (1102) can serve in a role as a client, network component, a server, a database or other persistency, or any other component (or a combination of roles) of a computer system for performing the subject matter described in the instant disclosure. The illustrated computer (1102) is communicably coupled with a network (1130) or cloud. In some implementations, one or more components of the computer (1102) may be configured to operate within environments, including cloud-computing-based, local, global, or other environment (or a combination of environments).

At a high level, the computer (1102) is an electronic computing device operable to receive, transmit, process, store, or manage data and information associated with the described subject matter. According to some implementations, the computer (1102) may also include or be communicably coupled with an application server, e-mail server, web server, caching server, streaming data server, business intelligence (BI) server, or other server (or a combination of servers).

The computer (1102) can receive requests over network (1130) or cloud from a client application (for example, executing on another computer (1102)) and responding to the received requests by processing the said requests in an appropriate software application. In addition, requests may also be sent to the computer (1102) from internal users (for example, from a command console or by other appropriate access method), external or third-parties, other automated applications, as well as any other appropriate entities, individuals, systems, or computers.

Each of the components of the computer (1102) can communicate using a system bus (1103). In some implementations, any or all of the components of the computer (1102), both hardware or software (or a combination of hardware and software), may interface with each other or the interface (1104) (or a combination of both) over the system bus (1103) using an application programming interface (API) (1112) or a service layer (1113) (or a combination of the API (1112) and service layer (1113). The API (1112) may include specifications for routines, data structures, and object classes. The API (1112) may be either computer-language independent or dependent and refer to a complete interface, a single function, or even a set of APIs. The service layer (1113) provides software services to the computer (1102) or other components (whether or not illustrated) that are communicably coupled to the computer (1102). The functionality of the computer (1102) may be accessible for all service consumers using this service layer. Software services, such as those provided by the service layer (1113), provide reusable, defined business functionalities through a defined interface. For example, the interface may be software written in JAVA, C++, or other suitable language providing data in extensible markup language (XML) format or other suitable format. While illustrated as an integrated component of the computer (1102), alternative implementations may illustrate the API (1112) or the service layer (1113) as stand-alone components in relation to other components of the computer (1102) or other components (whether or not illustrated) that are communicably coupled to the computer (1102). Moreover, any or all parts of the API (1112) or the service layer (1113) may be implemented as child or sub-modules of another software module, enterprise application, or hardware module without departing from the scope of this disclosure.

The computer (1102) includes an interface (1104). Although illustrated as a single interface (1104) in FIG. 11, two or more interfaces (1104) may be used according to particular needs, desires, or particular implementations of the computer (1102). The interface (1104) is used by the computer (1102) for communicating with other systems in a distributed environment that are connected to the network (1130). Generally, the interface (1104 includes logic encoded in software or hardware (or a combination of software and hardware) and operable to communicate with the network (1130) or cloud. More specifically, the interface (1104) may include software supporting one or more communication protocols associated with communications such that the network (1130) or interface's hardware is operable to communicate physical signals within and outside of the illustrated computer (1102).

The computer (1102) includes at least one computer processor (1105). Although illustrated as a single computer processor (1105) in FIG. 11, two or more processors may be used according to particular needs, desires, or particular implementations of the computer (1102). Generally, the computer processor (1105) executes instructions and manipulates data to perform the operations of the computer (1102) and any algorithms, methods, functions, processes, flows, and procedures as described in the instant disclosure. In some embodiments, a computer processor (1105) is one or more integrated circuits, one or more microcontrollers, and/or one or more parallel processors. For example, the computer processor may include various circuitry for operating a computer (1102) and related-computer devices. Additionally, the computer processor (1105) may correspond to a central processing unit (CPU) that is disposed on a printed circuit board with the computer (1102).

The computer (1102) also includes a memory (1106) that holds data for the computer (1102) or other components (or a combination of both) that can be connected to the network (1130). For example, memory (1106) can be a database storing data consistent with this disclosure. Although illustrated as a single memory (1106) in FIG. 11, two or more memories may be used according to particular needs, desires, or particular implementations of the computer (1102) and the described functionality. While memory (1106) is illustrated as an integral component of the computer (1102), in alternative implementations, memory (1106) can be external to the computer (1102).

The application (1107) is an algorithmic software engine providing functionality according to particular needs, desires, or particular implementations of the computer (1102), particularly with respect to functionality described in this disclosure. For example, application (1107) can serve as one or more components, modules, applications, etc. Further, although illustrated as a single application (1107), the application (1107) may be implemented as multiple applications (1107) on the computer (1102). In addition, although illustrated as integral to the computer (1102), in alternative implementations, the application (1107) can be external to the computer (1102).

There may be any number of computers (1102) associated with, or external to, a computer system containing computer (1102), each computer (1102) communicating over network (1130). Further, the term “client,” “user,” and other appropriate terminology may be used interchangeably as appropriate without departing from the scope of this disclosure. Moreover, this disclosure contemplates that many users may use one computer (1102), or that one user may use multiple computers (1102).

In some embodiments, the computer (1102) is implemented as part of a cloud computing system. For example, a cloud computing system may include one or more remote servers along with various other cloud components, such as cloud storage units and edge servers. In particular, a cloud computing system may perform one or more computing operations without direct active management by a user device or local computer system. As such, a cloud computing system may have different functions distributed over multiple locations from a central server, which may be performed using one or more Internet connections. More specifically, a cloud computing system may operate according to one or more service models, such as infrastructure as a service (IaaS), platform as a service (PaaS), software as a service (SaaS), mobile “backend” as a service (MBaaS), artificial intelligence as a service (AIaaS), serverless computing, and/or function as a service (FaaS).

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

While the disclosure has been described with respect to a limited number of embodiments, those skilled in the art, having benefit of this disclosure, will appreciate that other embodiments can be devised which do not depart from the scope of the disclosure as disclosed herein. Accordingly, the scope of the disclosure should be limited only by the attached claims.

What is claimed is:

1. A method, comprising:
obtaining first seismic data regarding a first geological region of interest, wherein the first seismic data comprises a offset gather that comprises a plurality of seismic traces sorted into an offset domain;
determining, by a computer processor, a pair of offset gathers based on a first predetermined multiple surface location and the offset gather;
determining, by the computer processor, a first trace index map for the pair of offset gathers;
generating, iteratively by the computer processor, a first convolution gather comprising a first plurality of convolution traces and based on a convolution function and the first trace index map,
wherein a respective convolution trace among the first plurality of convolution traces is determined using a first trace and a second trace from the pair of offset gathers;
determining, by the computer processor, a predicted surface-related multiple using the first convolution gather; and
generating, by the computer processor, filtered seismic data based on the predicted surface-related multiple and the first seismic data.

2. The method of claim 1, further comprising:
determining a plurality of pairs of offset gathers corresponding to an azimuth-offset domain and based on a plurality of predetermined multiple surface locations;
determining a second trace index map for the plurality of pairs of offset gathers; and
generating, iteratively, a second convolution gather based on the convolution function and the second trace index map,
wherein the plurality of predetermined multiple surface locations vary in two spatial dimensions.

3. The method of claim 1,
wherein the first trace index map corresponds to a plurality of predetermined multiple surface locations that vary in a single spatial dimension.

4. The method of claim 1, further comprising:
accumulating a plurality of convolution gathers for a second geological region of interest and based on second seismic data;
determining a plurality of predicted surface-related multiples based on the plurality of convolution gathers; and
performing an adaptive multiple subtraction operation on the second seismic data based on the plurality of predicted surface-related multiples,
wherein the adaptive multiple subtraction operation is based on least-squares adaptive filtering.

5. The method of claim 1,
wherein the first predicted surface-related multiple corresponds to a seismic reflection event that comprises a seismic wave that has at least one downward reflection from a surface of the earth.

6. The method of claim 1, further comprising:
acquiring, using a seismic surveying system comprising a plurality of seismic receivers and a seismic source, the first seismic data regarding the first geological region of interest.

7. The method of claim 1, further comprising:
generating a seismic image for the first geological region of interest based on the filtered seismic data;
determining a well path in the first geological region of interest using the seismic image; and
performing, using a drilling system, a drilling operation based on the well path.

8. The method of claim 1, further comprising:
generating a velocity model for the first geological region of interest using the filtered seismic data and a seismic inversion process;
generating a seismic image for the first geological region of interest based on the velocity model;
determining a plurality of interfaces within the first geological region of interest using the seismic image; and
determining, using the plurality of interfaces, a presence of hydrocarbons in the first geological region of interest.

9. The method of claim 1,
wherein the first predetermined multiple surface location corresponds to a location having a fixed offset between a seismic receiver and a seismic source.

10. A system, comprising:
a seismic surveying system comprising a plurality of seismic receivers and a seismic source; and
a seismic interpreter comprising a computer processor, wherein the seismic interpreter is coupled to the seismic surveying system, the seismic interpreter being configured to perform a method comprising:
obtaining first seismic data regarding a first geological region of interest, wherein the first seismic data is acquired using the seismic surveying system;
determining a pair of offset gathers based on a first predetermined multiple surface location and the offset gather;
determining a first trace index map for the pair of offset gathers;
generating, iteratively, a first convolution gather comprising a first plurality of convolution traces and based on a convolution function and the first trace index map,
wherein a respective convolution trace among the first plurality of convolution traces is determined using a first trace and a second trace from the pair of offset gathers;
determining a predicted surface-related multiple using the first convolution gather; and
generating filtered seismic data based on the predicted surface-related multiple and the first seismic data.

11. The system of claim 10, wherein the method further comprises:
determining a plurality of pairs of offset gathers corresponding to an azimuth-offset domain and based on a plurality of predetermined multiple surface locations;
determining a second trace index map for the plurality of pairs of offset gathers; and
generating, iteratively, a second convolution gather based on the convolution function and the second trace index map,
wherein the plurality of predetermined multiple surface locations vary in two spatial dimensions.

12. The system of claim 10, wherein the method further comprises:
wherein the first trace index map corresponds to a plurality of predetermined multiple surface locations that vary in a single spatial dimension.

13. The system of claim 10, wherein the method further comprises:
accumulating a plurality of convolution gathers for a second geological region of interest and based on second seismic data;
determining a plurality of predicted surface-related multiples based on the plurality of convolution gathers; and
performing an adaptive multiple subtraction operation on the second seismic data based on the plurality of predicted surface-related multiples,
wherein the adaptive multiple subtraction operation is based on least-squares adaptive filtering.

14. The system of claim 10,
wherein the first predicted surface-related multiple corresponds to a seismic reflection event that comprises a seismic wave that has at least one downward reflection from a surface of the earth.

15. The system of claim 10, wherein the method further comprises:
generating a seismic image for the first geological region of interest based on the filtered seismic data; and
determining a well path in the first geological region of interest using the seismic image.

16. The system of claim 15, further comprising:
a drilling system comprising a drill string and a drill bit,
wherein the drilling system is configured to perform a drilling operation based on the well path.

17. The system of claim 10, wherein the method further comprises:
generating a velocity model for the first geological region of interest using the filtered seismic data and a seismic inversion process;
generating a seismic image for the first geological region of interest based on the velocity model;
determining a plurality of interfaces within the first geological region of interest using the seismic image; and
determining, using the plurality of interfaces, a presence of hydrocarbons in the first geological region of interest.

18. The system of claim 10,
wherein the first predetermined multiple surface location corresponds to a location having a fixed offset between a seismic receiver and a seismic source.
